(19) United States
(12) Patent Application Publication
(10) Pub. No.: US 2024/0346542 A1
(43) Pub. Date: Oct. 17, 2024

(54) Interactive Payment Card Processing System with Application Services

(71) Applicant: VeteranCrowd Rewards, Inc., Cobbs Creek, VA (US)

(72) Inventors: Patrick K. Brady, Lombard, IL (US); Robert P. Louthan, Cobbs Creek, VA (US)

(21) Appl. No.: 18/633,580

(22) Filed: Apr. 12, 2024

Related U.S. Application Data
(63) Continuation-in-part of application No. 18/252,725, filed on May 12, 2023.
(60) Provisional application No. 63/495,611, filed on Apr. 12, 2023.

(51) Int. Cl. G06Q 30/0207; G06Q 20/02; G06Q 20/24

(52) U.S. Cl. CPC G06Q 30/0215; G06Q 20/023; G06Q 20/24

(57) ABSTRACT

A purchase message is received when an affinity credit card holder makes a purchase. The credit card holder and the merchant are determined from the message. A discount is determined from a database. A discount amount is calculated from the discount. An entry is created for the discount amount from a merchant to the affinity credit card holder in the database. A process is periodically executed that searches the database for discounts that occurred within a time period. Discount amounts are summed for each merchant. A merchant funds transfer is communicated to a payment processor that transfers each discount amount for each merchant from a bank account of each merchant to a bank account of the affinity company. A card holder funds transfer is communicated to a payment processor that transfers the discount amount from the bank account of the affinity company to the credit card holder.

### RELATED APPLICATIONS

This application claims the benefit of U.S. Provisional Patent Application Ser. No. 63/495,611, filed on Apr. 12, 2023, and is a continuation-in-part application of U.S. patent application Ser. No. 18/252,725, filed May 12, 2023, the disclosure of all of which is incorporated by reference herein in their entireties.

### BACKGROUND

### Field of the Invention

Embodiments of the present invention are directed to processing of credit card transactions and information flow related to card use. More specifically, embodiments are directed to systems and methods for applying a discount to an account of an affinity credit card holder.

### Background of the Invention

Consumer credit card processing began in 1946 with the advent of the Charg-it card created by Brooklyn banker John Biggins. Charg-it purchases were forwarded to Biggins' bank where the transaction was settled by payment to the Merchant and payment from the Customer. Diner's Club debuted in 1950 soon becoming the largest “charge card” (Paid in full at the end of each month). American Express reached 1,000,000 customers by 1964 after 5 years of launching their card.

Innovations in the credit card processing industry have centered around better security and embrace of available digital storage and communications technology. At the point of sale, IBM introduced the magnetic stripe to cards in 1960. RFID solutions were added giving way to Europay, MasterCard, and Visa (EMV) computer chip cards in use today. Network interconnections in banking have led to faster and more secure credit card network processing. Fraud prevention software, such as neural networks, began to be introduced in the 1990s with this becoming a robust area of business today (e.g., Actimize, SAS, BAE Systems and others).

### SUMMARY

Embodiments are directed to Credit Card Processing systems or more appropriately Interactive Credit Card Processing systems.

Embodiments bring a number of innovations to the credit card processing industry. One embodiment addresses the need for more advanced rewards cards. In this embodiment, card holders are informed of local Merchant discounts through a smart phone App or website. Credit cards are enrolled in affinity programs by an organization that contacts card holders or has existing relationships with cardholders. Enrollment results in notification of the Central Credit Card Processing Network requesting tracking of the transactions on the card. After enrollment, this card can now be used in affinity offerings and called an affinity card. Use of affinity cards is monitored by a process running in an Application Processor connected to the Central Credit Card Processing Network. When a Central Credit Card Processing Network discovers a transaction from an affinity card, the transaction results in a notification to the Application Processor where it is evaluated for qualifying discounts or other promotions in a database which is part of the Application Server. For a qualified transaction, that is, a transaction the Application Processor discovers qualifies for a discount or other promotion (through connection to a central card processor network interface), the Application Processor then makes an entry in a database related to the cardholder's account to assess fees and track a discount amount. Software in the application processor then alerts the card holder to the discount received or other promotion via messaging to the App or via text messaging services.

In another embodiment, Merchants interact with the credit card processing system through a Merchant Portal. In this portal, Merchants are able to set discount levels, establish rules for discount campaigns such as time frames, triggers based on transaction levels, or other data or sets of rules for other promotions. These rules may be combined with their own corporate data such as customer profiles, inventory, staffing, etc. Historical reporting and live dashboard display systems are delivered through the portal in an unprecedented control and display data system for card transaction processing.

In an embodiment, merchant defined discount programs, and/or other promotions are communicated to card holders through an App. Communication may be in the form of active messaging and alerts, or be available passively to those who search using the App. For instance, lunch specials at a restaurant may be offered on a slow day, generating alerts to nearby card holder's Apps. Alternately, or in addition, a lunch special may be defined and discovered through searches performed by App owners.

Merchants have high interest in the results of their campaigns. Card holder's card use creates a definitive trail of use that may feed historical reports or a live dashboard. Such data access leads to feedback into refinement of campaigns through the portal. Card use may also be combined with other data available from the system such as location of the cardholder in the Smartphone App.

In another embodiment, campaign discount levels or other offered benefits, such as other promotions, may be adjusted depending on live data feeds from the Application Server.

In another embodiment, affinity cards, as described in previous embodiments, participate in round up programs where rounded up revenue is tracked and managed for purposes such as donation to service organizations.

### BRIEF DESCRIPTION OF THE FIGURES

The skilled artisan will understand that the drawings, described below, are for illustration purposes only. The drawings are not intended to limit the scope of the present teachings in any way.

FIG. 1 is a system diagram showing elements in an Interactive Credit Card Processing System with Application Services and how they relate to each other, in accordance with various embodiments.

FIG. 2 is a process diagram with system elements, in accordance with various embodiments.

FIG. 3 shows the Interactive Control Process main loop message handler with example messages, in accordance with various embodiments.

FIG. 4 shows a sample message header and example fields from system messages sent between processes, in accordance with various embodiments.

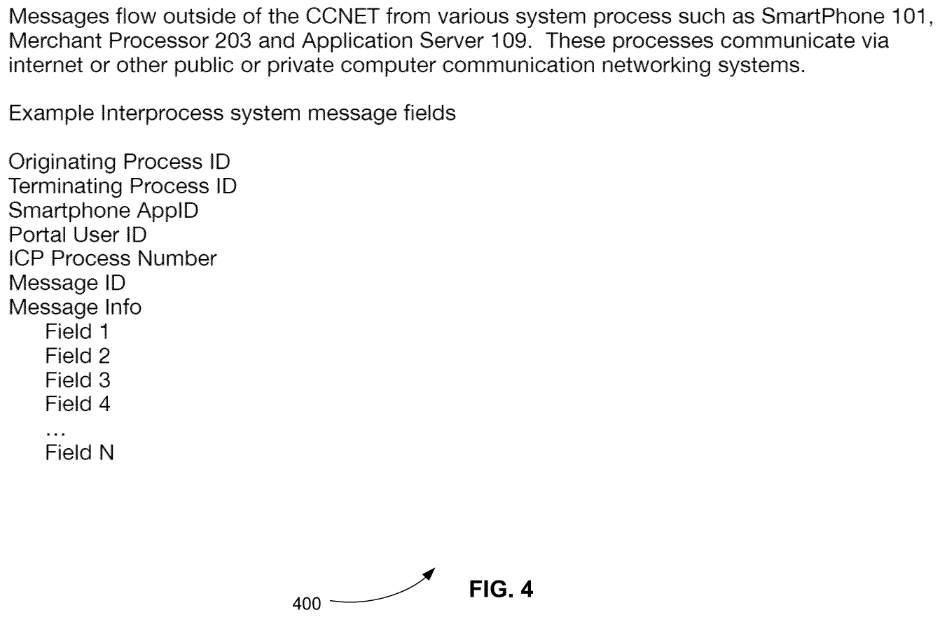

FIG. 5 shows an example data fields in a Cardholder data structure, in accordance with various embodiments.

FIG. 6 shows an example of fields in a Merchant data structure, in accordance with various embodiments.

FIG. 7 shows an example screen of a smartphone App displaying a sample list of Merchants and associated discounts in a local region, in accordance with various embodiments.

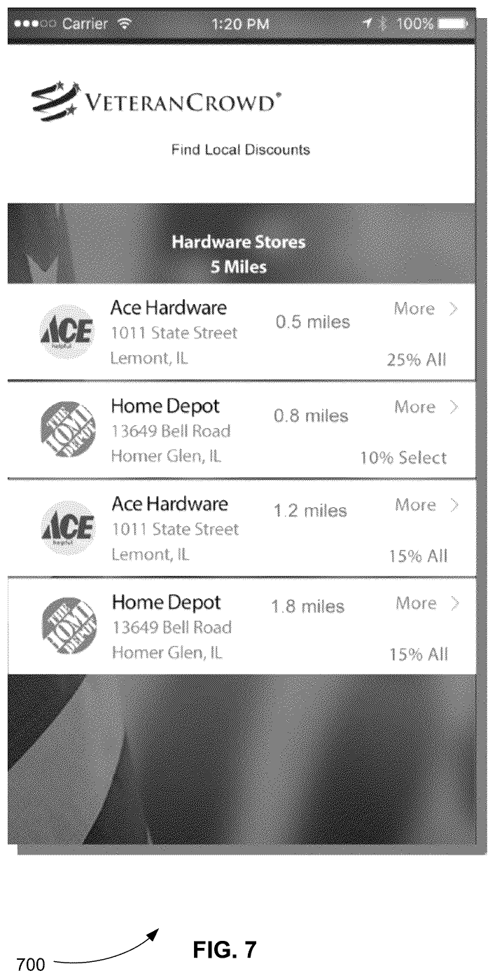

FIG. 8 shows standard payment card transaction Authorization Request message flow between system elements, in accordance with various embodiments.

FIG. 9 shows standard payment card transaction Authorization Response message flow between system elements, in accordance with various embodiments.

FIG. 10 shows discount payment card transaction Authorization Request message flow between system elements, in accordance with various embodiments.

FIG. 11 shows fields available in the Square POS transaction processing message payload as part of their API, in accordance with various embodiments.

FIG. 12 includes Table 1 and Table 2 that show the most commonly used message types and fields from ISO 8583 financial system protocol, in accordance with various embodiments.

FIG. 13 is a block diagram that illustrates a computer system, upon which embodiments of the present teachings may be implemented.

FIG. 14 is an exemplary flowchart showing a method for applying a discount to an account of an affinity credit card holder, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DETAILED DESCRIPTION

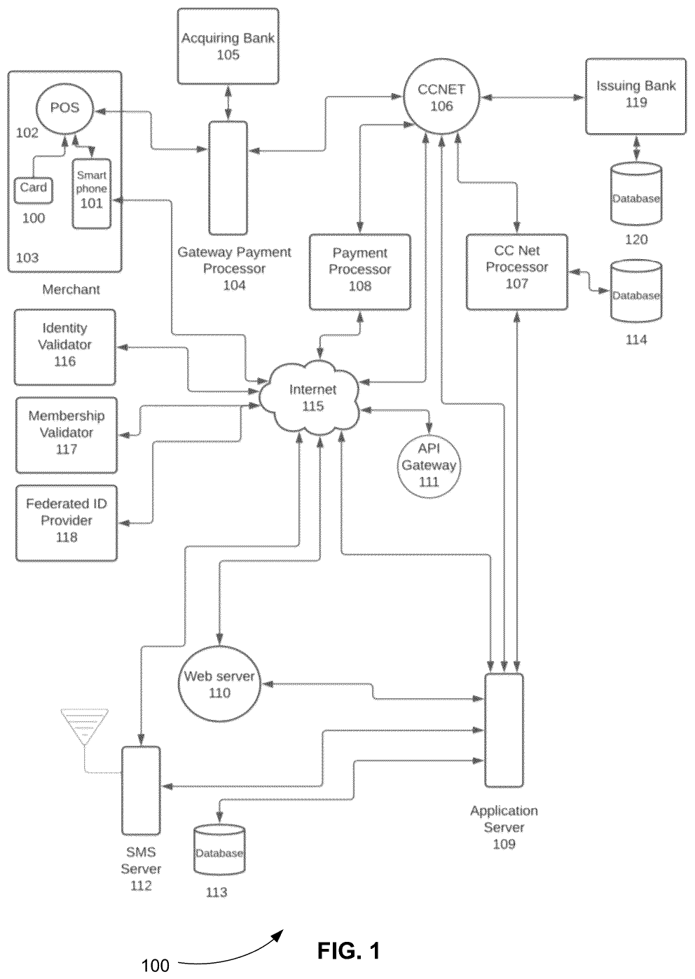

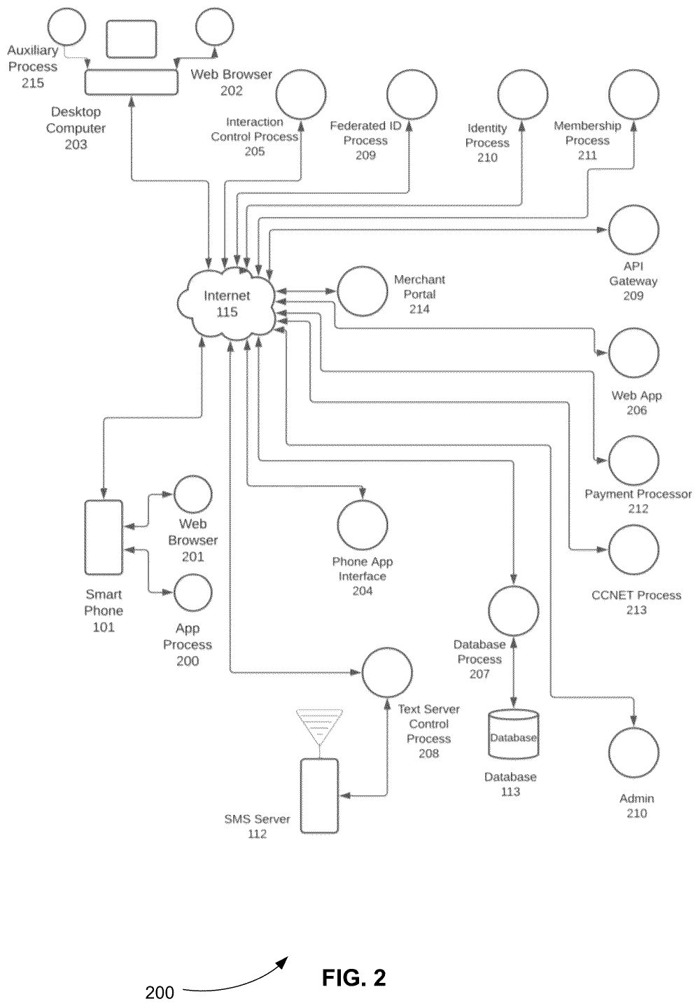

FIG. 1, for example, is a system diagram showing the interaction of an affinity company Application Server 109 with a credit card network (CCNET) 106, among other devices. FIG. 2 is, for example, a process diagram showing some of the processes or software components running on Application Server 109 and their interaction with processes of other devices.

In reference to FIGS. 1 and 2, in one embodiment, an affinity company would like to attract card holders by creating an affinity rewards program using a credit card. The affinity company partners with a large Credit Card Network company to create affinity cards for customers. The large Credit Card Network company adds new customer account information including card number to its database 114. The affinity company creates entries in a database 113 of card holders which may contain card numbers or a tokenized number representing the card number for security reasons as is commonly known in the art. Other data stored by the affinity company in the Cardholder data entry can include identification information such as name, address, email, loginID and password (which may be encrypted) for the phone App 200 or Web App 206 as well as Organizations IDs or organizations the Cardholder belongs to which may have qualified discount programs or other benefit programs. It is important to note that embodiments create a platform for consolidation of rewards from multiple organizations and can provide an all-in-one rewards service for purchases of any kind at any location including online. While the description of this invention illustrates rewards such as discounts or other promotions related to Organizations IDs there are other ways to group rewards. For instance, a discount or other promotion may be applied for all purchases at a Merchant or just for purchases of specific items or classes of items. A reward need not be a discount but might be a service or an action, an alarm, a notification or a gift, or other promotions.

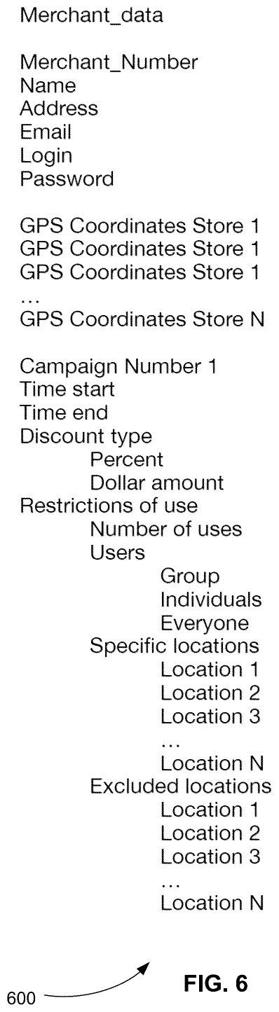

In an embodiment, a Merchant 103 creates an account with the affinity company on their Merchant Portal website 214 served by a Web Server 110 using web browser 202 executing on computer 203 through internet cloud 115 for purposes of creating rewards, such as discounts or other promotions, for Cardholders of the affinity company which will attract them to the Merchant's locations. For example, the Merchant may define campaigns to offer discounts during a specified time period or at specific locations. The campaign may be for all members of an organization or restricted in some way, perhaps even just for a specific Cardholder or group of Cardholders. Data defining the campaign is stored in database 113 as shown, for example, in FIG. 6 for the Merchant under its Merchant Number. As shown in FIG. 6, data defining the campaign includes data for implementing a campaign's rules, including, for example, campaign identification, Merchant identification, geographic scope, campaign start and stop dates and times, number of users and their identifications, discount amount and type or data for another type of promotion, and any other data required to implement the rules of a particular campaign. Note that not all of the exemplary data is always required for a particular campaign and other data may be required for a different campaign.

In an embodiment, a Cardholder would like to know the Merchants in the area offering rewards for their Organization. A smart phone 101 running an application 200, such as a smartphone application, is created by the affinity company, which provides geographic display of local Merchants and their discount levels or other promotions. Merchant discount data can be searched by category or keyword or simply viewed as a map with “pin” drops as is known to those in the art.

Smartphone App 200 communicates to the Application Database 113 via database Process software 207 running on the Application server 109 through Phone App Interface (PAI) Process 204 and DB Process 207 directly or through Phone App 204, followed by Interaction Control Process (ICP) 205 running on Application Server 109 and then ultimately DB Process 207. Alternate paths are available for high-speed download of larger data objects (direct) or processing (indirect).

Application 200's main interaction with Database 113 is to gather Merchant information. In an embodiment, application 200 passes global positioning satellite (GPS) corner coordinates of a screen displayed map to Interaction Control Process (ICP) 205. ICP 205 searches Database 113 via Database Process 207 for Merchants within the GPS corner coordinates of the map region. Merchant data indicating those merchants in the geographic area defined by the corner GPS coordinates for the map region is returned from ICP 205 through PAI 204 to App process 200 and finally displayed on smartphone 101.

In an embodiment, a cardholder running Web App 206 needs to securely login. Web App 206 communicates to Identity Process 210 running in Identity Validator 116. Identity Process 210 may verify the ID of the user in a number of ways. It may take login ID and password information and look in database 113 for a match. It may look to match a federated ID in Federated ID Process 209 running in Federated ID Provider server 118 using OAUTH methods known to those in the art.

The cardholder running Web App 206 may authenticate their membership in an affinity group by communication with Membership Process 211 running in Membership Validator server 117. For example, veteran affinity group status may be validated by calling the API endpoint of the Veterans Administration with the proper parameters.

In an embodiment, the CCNET process 213 running in CCNET 106 passes a message to ICP 205 running in Application Server 109 when a member makes a purchase with their registered credit card. ICP 205 obtains the merchant ID from the message and looks in database 113 running in Application Server 109 for a discount offered by that merchant (by communicating with Database Process 207). In the event of a match, the amount of the discount is calculated and an entry is created in database 113 to track the discount.

In an embodiment, a daily process checks the database 113 for discounts that are thirty days old. These discounts are summed for each merchant and an ACH debit is applied using Payment Processor 212 running in Payment Processor 108 to move funds from the merchant's bank account to a bank account of the rewards operator. These funds are then distributed to cardholder's bank account or credit card account via API calls to the Payment Processor 212.

In an embodiment, communications between processes may take place using the services of an API Gateway Process 209 residing on API Gateway server 111.

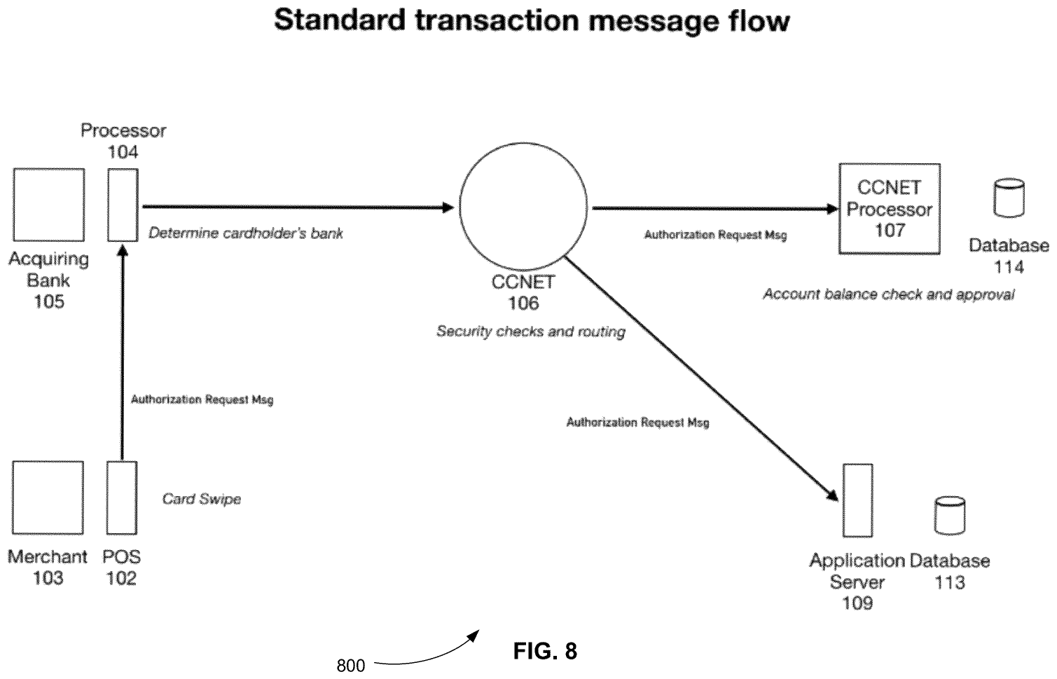

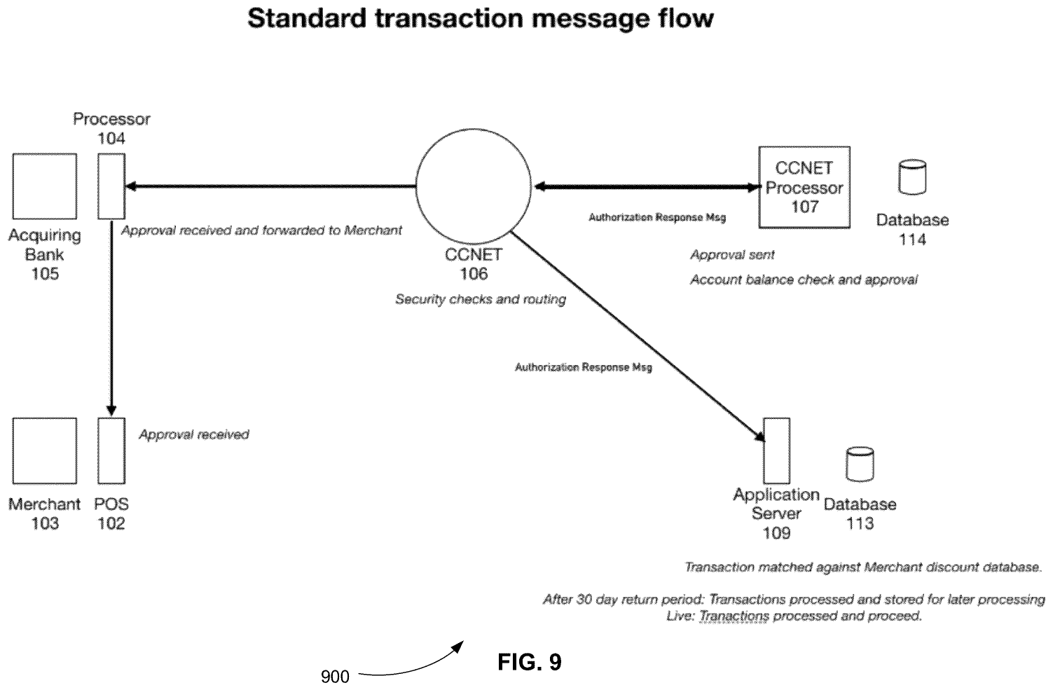

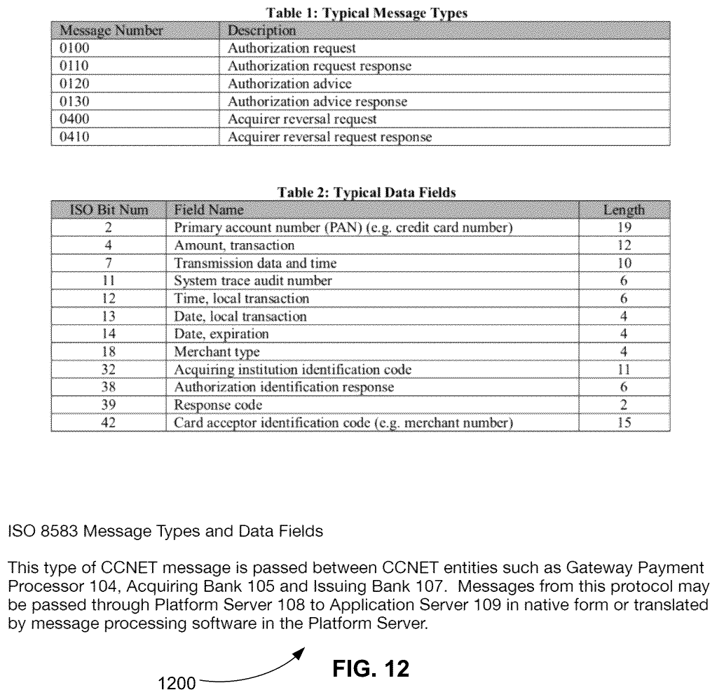

In an embodiment, application 200 may have many features to add convenience to the Cardholder. For instance, directions may be supplied after the Cardholder makes a point selection of a particular merchant. The point selection can be through touching a touch screen or using a pointing device such as a mouse, for instance. Once a Cardholder has made a purchase at the Merchant, Card 100 or Smartphone 101 (through digital wallet and NFC or other methods known in the art) interacts with a point-of-sale (POS) system 102 at the merchant to begin the payment process. Card information such as the card number is combined with purchase information entered at the POS 102 via scanning or manual input in methods known to those in the art and passed to Gateway payment processor 104 and then to Acquiring Bank 105. Acquiring Bank 105 is the bank that acquires the Cardholder information and transaction details for presentation to and approval by Issuing Bank 119. Messages between entities in the credit card system widely use the ISO 8583 message protocol as shown in FIG. 8 and FIG. 9 and Table 1 and 2 of FIG. 12. POS 102 passes an ISO 8583 Authorization Request message to the Acquiring Bank 105 that then communicates it to the Issuing Bank 119. In a typical transaction, the Issuing Bank 119 checks the available funds in the Cardholder's account in database 120 and marks the transaction approved or denied.

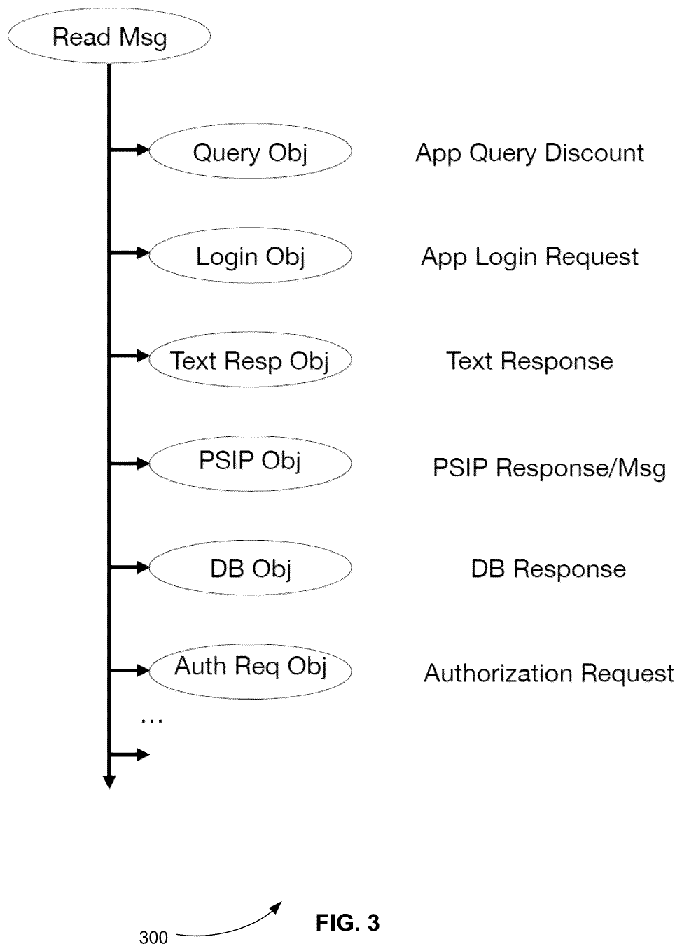

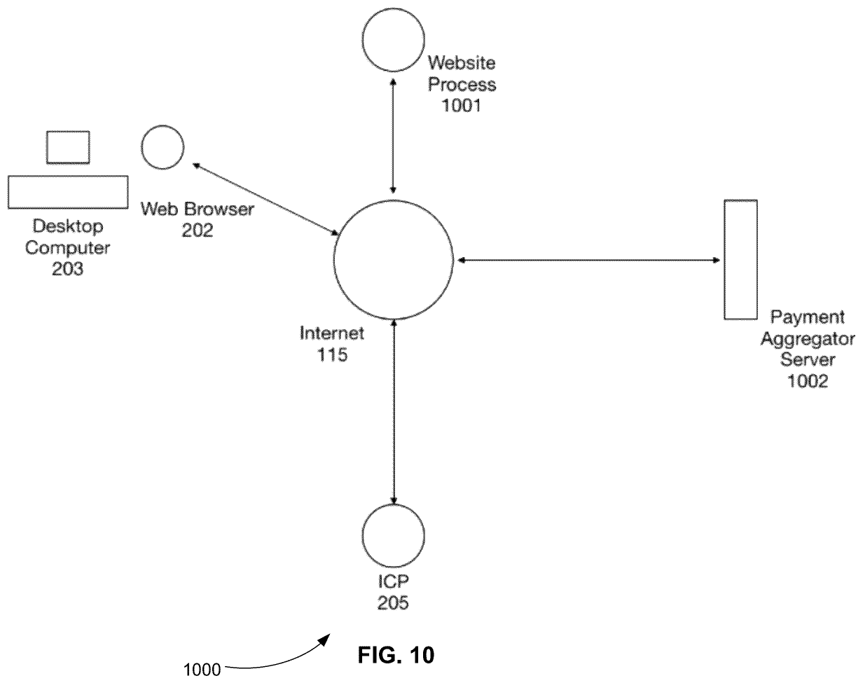

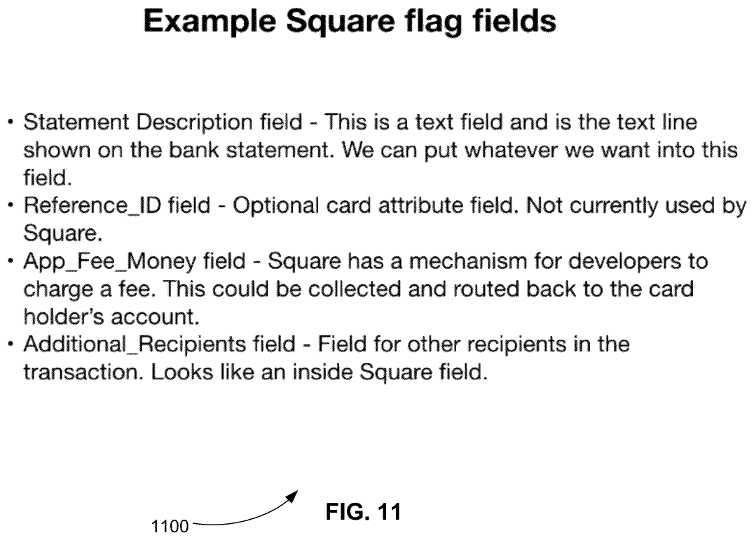

In an embodiment, CCNET 106 communicates a transaction information message to Application Server 109 either directly or via API Gateway 111. CCNET Processors and CCNET networks are available from companies like VISA, MasterCard and AMEX and usually provide their own message protocols and APIs for interface. Interaction Control Process 205 is passed incoming messages from CCNET and ICP 205 for processing. FIG. 3 shows an example of a basic message processing loop in ICP 205. In an embodiment, the Authorization Request message sent to the Issuing Bank 119, as shown in FIG. 10 and FIG. 11, results in a call to Query Obj in the App Query Discount message handler. Other messages, such as the Authorization Response message may be used as a trigger to App Query Discount. The Authorization Response message contains information regarding the approval or denial of the transaction and is the best source for triggering discount processing.

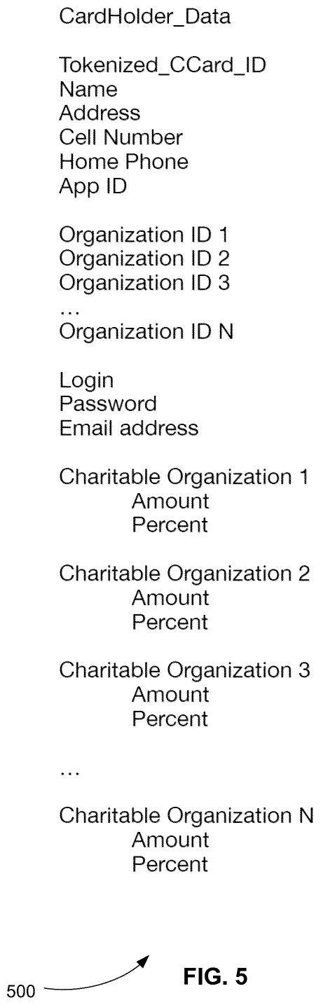

In an embodiment, App Query Discount reads database 113 for the Cardholder's tokenized card number and associated information such as that shown in FIG. 5 to see if this cardholder qualifies for any discounts or other promotions from any Organizations. Next the Merchant Number is used to query database 113 for information such as that shown in FIG. 6 for Organizations that offer discounts (or other promotions) and other discount (or other promotion) qualifying information such as times of valid discounts (or other promotions). If there is a discount match for this Cardholder and this merchant then the discount is calculated and the amount of the discount is stored for batch processing (usually in 30 days).

Should the reward be another type of promotion, then information relevant to that type of promotion is stored in database 113 and sent to the Cardholder via Text Server Control Process 208 running in SMS Server 112 (for example) or to the Smartphone App Process 200 for display and alerting.

In an embodiment, some merchants may have discount programs in place for affinity group members that can be applied at checkout. In this case, the POS system 102 should flag the transaction as “discount applied” so the ICP software process 205 and its subprocesses do not perform a second discount. This flag can be any unused field or any extension value in a field of the ISO 8583 Authorization Request message. Alternately, the POS system 102 can send a notification message out of band (via internet 115) to ICP 205 containing the transaction code so that this can be matched to an existing discounted transaction, preventing a double dip discount if desired.

In an embodiment, the POS system of the merchant will pass details about the items purchased so these can be checked for discounting at the authorization and settlement processing. This information can either be “in band” of the 8583 messages or alternately, it can be passed “out of band”, in a variety of ways known to those in the art, to the Issuing Bank 119 and/or the Application Server 109. This method is useful when discounts are being applied only to specific items within the purchase.

In an embodiment, the ICP 205 continues by sending a notification message to Text Services Control Process 208 in SMS Server 112 to cause a text message or message to Smartphone App 200 to be sent to Smartphone 101 alerting the Cardholder they just received a discount from their Merchant on the purchase. The ICP 205 also makes an entry of the transaction, including purchase amount and discount amount in the database 113 by sending a message to DB process 207.

In some types of transactions, it is not possible to know the discounted amount at the time of the Authorization Request. For example, restaurants (tips are added), gas stations (the amount of gas purchased isn't known until the tank is full) and hotels (service charges may accrue during the stay). In cases like these it is still valuable to inform the cardholder that they are making a purchase from a merchant that will provide a discount and a message to that effect can be sent. A second text message or message to Smartphone App 200 may also be sent once the final payment amount is known. In the case of restaurants this could be the next day and hotels this could be the day after checking out. Even so, it is still of value and messages documenting the enjoyed discount can be triggered by the transaction complete message sent by the CCNET provider.

In an embodiment, DB 113 accumulates data on Cardholders' activities that are of significant interest to Cardholders as well as Merchants. Admin process 210 produces reports to Cardholders or Merchants at the end of each month assembling financial transaction data from DB 113 and optionally DB 114. Merchant Portal process 110 contains code to create reports on Cardholder activity that can be assembled and displayed as is known in the art.

In an embodiment, ICP 205 performs a number of other functions as part of the Authorization Request processing. For instance, qualified discount Cardholders may wish part of their discount to be passed to a charitable organization. ICP 205 queries the DB 113 to check for charitable contribution election in the Cardholders profile. If there is a charitable election then ICP 205 sends a message to the Application Server 109 to direct funds from the Cardholder's account representing the proper portion of the transaction discount to the appropriate charitable account.

In another embodiment, Cardholder purchases contained in DB 113 can be searched by Auxiliary Process 215 running database software in Desktop Computer 203 for trends in Cardholder purchases and other behavior such as location and activity from Smartphone 101 and collected and communicated through application process 200. Optimized offerings of discounts or other rewards advantageous to Cardholders may be identified and created by database analysis. For instance, purchasing trends of a cardholder at lunch time when in a certain area may suggest a discount reward from a Merchant would be of interest. An Auxiliary Process 215 running in Desktop Computer 203 might then communicate this opportunity to Merchants through Merchant Portal 110. In an embodiment, opportunities for cardholder rewards may be presented to multiple Merchants to be passed via an auction to the Merchant that is the highest bidder.

In an embodiment, the credit card application processing system described can be paired with an aggregated payment processing system such as PayPal. FIG. 10 shows how the payment processed in an online purchase can interact with the credit card application processing system to enable discount processing. A customer using Web Browser 202 is making a purchase on Website 1001. In checkout, Website Process 1001 messages Payment Aggregator Server 1002. Payment Aggregator Server 1002 validates the ability of the customer to pay and responds to both the Website Process 1001 with an authorization response and ICP 205 through a web hook or interprocess message as is known in the art. In this embodiment, ICP 205 processes the notification for ACH payment of the discount at a later time in a method known to those in the art.

In another embodiment, the credit card application processing system described is paired with an aggregated payment processing system such as PayPal. FIG. 10 shows how the payment processed in an online purchase can interact with the credit card application processing system to enable discount processing. A customer using Web Browser 202 is making a purchase on Website 1001. In checkout, Website Process 1001 messages Payment Aggregator Server 1002. Payment Aggregator Server 1002 validates the ability of the customer to pay and contacts ICP 205 with an interprocess message or webhook. ICP 205 performs checks of the database 113 and makes necessary adjustments of discount or rewards as described in previous embodiments or includes coupon codes for discount at the website as identified in database 113. ICP 205 then responds to Payment Aggregator Server 1002 with the modified data for the transaction. The Payment Aggregator Server 1002 then proceeds to complete the transaction with the Website Process 1001.

In an embodiment, integration of the credit card processing system with credit cards and payment aggregators creates a ubiquitous discount processing system where customers can shop both at stores and on the internet and receive automated discounts and other benefits of the system. This is a very powerful new method of providing discounts and other rewards.

### Computer-Implemented System

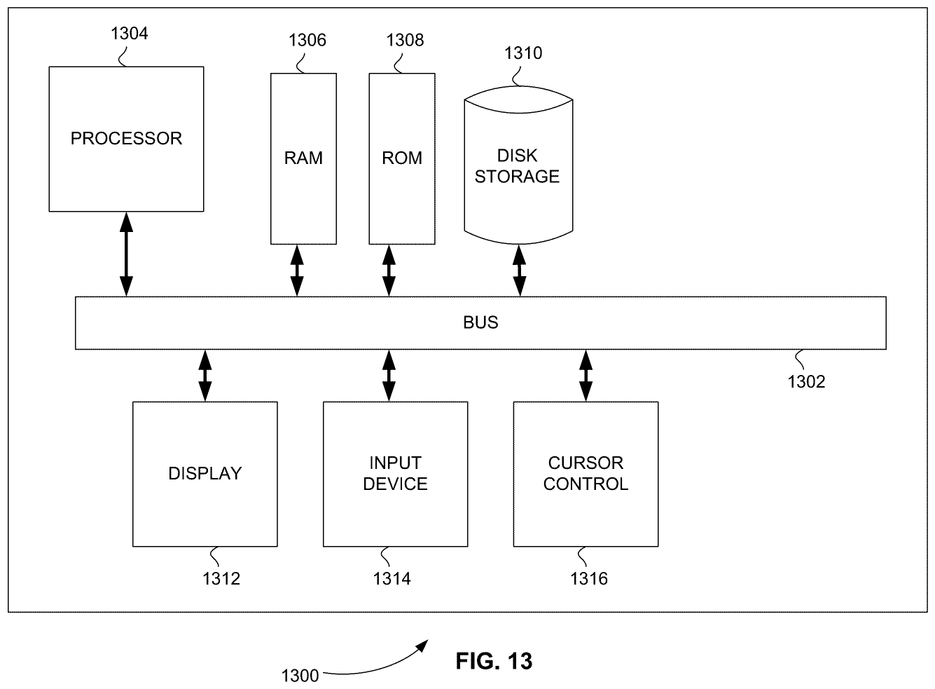

FIG. 13 is a block diagram that illustrates a computer system 1300, upon which embodiments of the present teachings may be implemented. Computer system 1300 includes a bus 1302 or other communication mechanism for communicating information, and a processor 1304 coupled with bus 1302 for processing information. Computer system 1300 also includes a memory 1306, which can be a random-access memory (RAM) or other dynamic storage device, coupled to bus 1302 for storing instructions to be executed by processor 1304. Memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312, such as a cathode ray tube (CRT) or liquid crystal display (LCD), for displaying information to a computer user. An input device 1314, including alphanumeric and other keys, is coupled to bus 1302 for communicating information and command selections to processor 1304. Another type of user input device is cursor control 1316, such as a mouse, a trackball or cursor direction keys for communicating direction information and command selections to processor 1304 and for controlling cursor movement on display 1312.

A computer system 1300 can perform the present teachings. Consistent with certain implementations of the present teachings, results are provided by computer system 1300 in response to processor 1304 executing one or more sequences of one or more instructions contained in memory 1306. Such instructions may be read into memory 1306 from another computer-readable medium, such as storage device 1310. Execution of the sequences of instructions contained in memory 1306 causes processor 1304 to perform the process described herein.

Alternatively, hard-wired circuitry may be used in place of or in combination with software instructions to implement the present teachings. For example, the present teachings may also be implemented with programmable artificial intelligence (AI) chips with only the encoder neural network programmed—to allow for performance and decreased cost. Thus, implementations of the present teachings are not limited to any specific combination of hardware circuitry and software.

The term “computer-readable medium” or “computer program product” as used herein refers to any media that participates in providing instructions to processor 1304 for execution. The terms “computer-readable medium” and “computer program product” are used interchangeably throughout this written description. Such a medium may take many forms, including but not limited to, non-volatile media and volatile media. Non-volatile media includes, for example, optical or magnetic disks, such as storage device 1310. Volatile media includes dynamic memory, such as memory 1306.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

In various embodiments, computer system 1300 can be connected to one or more other computer systems, like computer system 1300, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

Various forms of computer readable media may be involved in carrying one or more sequences of one or more instructions to processor 1304 for execution. For example, the instructions may initially be carried on the magnetic disk of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector coupled to bus 1302 can receive the data carried in the infra-red signal and place the data on bus 1302. Bus 1302 carries the data to memory 1306, from which processor 1304 retrieves and executes the instructions. The instructions received by memory 1306 may optionally be stored on storage device 1310 either before or after execution by processor 1304.

In accordance with various embodiments, instructions configured to be executed by a processor to perform a method are stored on a computer-readable medium. The computer-readable medium can be a device that stores digital information. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

In various embodiments, the software described herein include any type of artificial intelligence algorithm including, but not limited to, a machine learning algorithm.

### System for Applying Affinity Card Discounts

FIG. 1 shows a system for applying a discount to an account of an affinity credit card holder, in accordance with various embodiments. The system of FIG. 1 includes affinity company database 113 and affinity company server 109.

Affinity company server 109 receives a purchase message from CCNET 106 when an affinity credit card holder makes a purchase. Affinity company server 109 determines the affinity credit card holder and a merchant identifier (ID) from the message. Affinity company server 109 determines a discount from affinity company database 113 using the merchant ID. Affinity company server 109 calculates a discount amount from the discount. Affinity company server 109 creates an entry for the discount amount from a merchant with the merchant ID to the affinity credit card holder in affinity company database 113. Affinity company server 109 periodically executes a process that searches affinity company database 113 for discounts that occurred within a time period. Affinity company server 109 sums discount amounts for each merchant for the time period, producing a discount amount for each merchant. Affinity company server 109 communicates a merchant funds transfer to payment processor 108 for the time period. Payment processor 108 transfers each discount amount for each merchant from a bank account of each merchant to a bank account of the affinity company. Finally, affinity company server 109 communicates a card holder funds transfer to payment processor 109 for the time period. Payment processor 108 transfers the discount amount for the entry in the affinity company database from the bank account of the affinity company to the affinity credit card holder.

In various embodiments, the merchant funds transfer and the card holder funds transfer are automated clearing house (ACH) network transfers.

In various embodiments, the card holder transfer transfers the discount amount for the entry in affinity company database 113 from the bank account of the affinity company to a bank account of the affinity credit card holder.

In various embodiments, the card holder transfer transfers the discount amount for the entry in affinity company database 113 from the bank account of the affinity company to a credit card account of the affinity credit card holder.

In various embodiments, the time period is 30 days.

In various embodiments, the system further includes short message service (SMS) server 112.

In various embodiments, affinity company server 109 sends the discount to SMS server 112 and SMS server 112 sends the discount as a text to a smartphone (101 of FIG. 2) of the affinity credit card holder.

In various embodiments, affinity company server 109 further determines the discount includes a promotion, affinity company server 109 sends the promotion to SMS server 112 and SMS server 112 sends the promotion as a text to a smartphone (101 of FIG. 2) of the affinity credit card holder.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

### Method for Applying Affinity Card Discounts

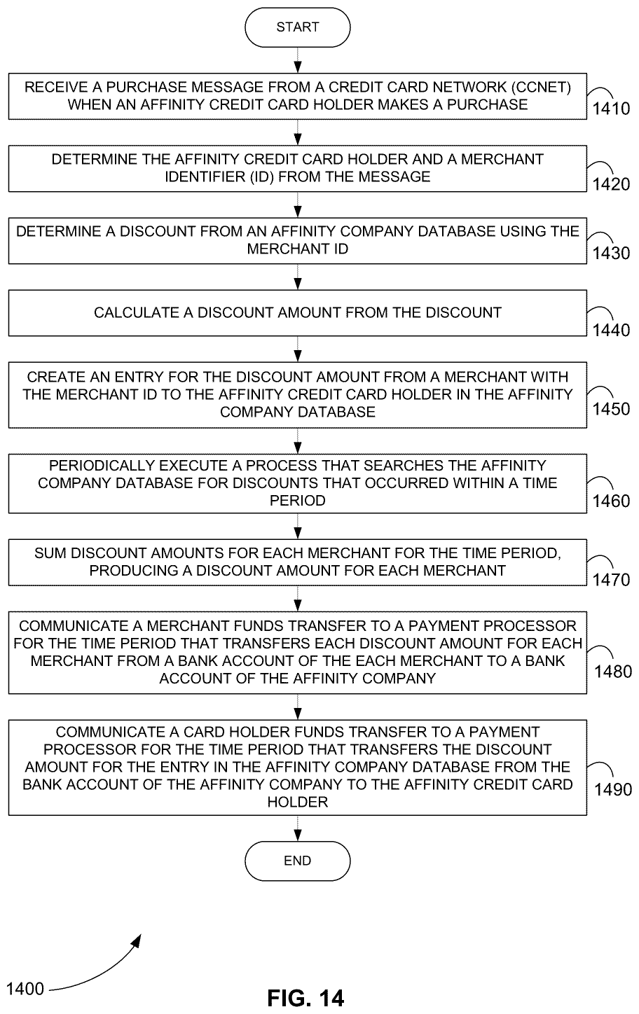

FIG. 14 is an exemplary flowchart showing a method 1400 for applying a discount to an account of an affinity credit card holder, in accordance with various embodiments.

In step 1410 of method 1400, a purchase message is received from a credit card network (CCNET) when an affinity credit card holder makes a purchase.

In step 1420, the affinity credit card holder and a merchant identifier (ID) are determined from the message.

In step 1430, a discount is determined from an affinity company database using the merchant ID.

In step 1440, a discount amount is calculated from the discount.

In step 1450, an entry is created for the discount amount from a merchant with the merchant ID to the affinity credit card holder in the affinity company database.

In step 1460, a process is periodically executed that searches the affinity company database for discounts that occurred within a time period.

In step 1470, discount amounts are summed for each merchant for the time period, producing a discount amount for each merchant.

In step 1480, a merchant funds transfer is communicated to a payment processor for the time period that transfers each discount amount for each merchant from a bank account of each merchant to a bank account of the affinity company.

In step 1490, a card holder funds transfer is communicated to a payment processor for the time period that transfers the discount amount for the entry in the affinity company database from the bank account of the affinity company to the affinity credit card holder.

### Computer Program Product for Applying Affinity Card Discounts

In various embodiments, a computer program product includes a non-transitory tangible computer-readable storage medium whose contents include a program with instructions being executed on a processor so as to perform a method for applying a discount to an account of an affinity credit card holder. The processor can be, but is not limited to, a computer, a microprocessor, the computer system of FIG. 13, or any device capable of sending, receiving, and analyzing data. This method is performed by a system that includes one or more distinct software modules.

FIG. 2 is a schematic diagram of a system 200 that includes one or more distinct software modules and that performs a method for applying a discount to an account of an affinity credit card holder, in accordance with various embodiments.

Interaction control process (ICP) module 205 receives a purchase message from a credit card network (CCNET) when an affinity credit card holder makes a purchase.

Database process module 207 determines the affinity credit card holder and a merchant identifier (ID) from the message. Database process module 207 determines a discount from an affinity company database using the merchant ID. Database process module 207 calculates a discount amount from the discount. Database process module 207 creates an entry for the discount amount from a merchant with the merchant ID to the affinity credit card holder in the affinity company database. Database process module 207 periodically executes a process that searches the affinity company database for discounts that occurred within a time period. Database process module 207 sums discount amounts for each merchant for the time period, producing a discount amount for each merchant.

Payment processor module 212 communicates a merchant funds transfer to a payment processor for the time period that transfers each discount amount for each merchant from a bank account of each merchant to a bank account of the affinity company. Payment processor module 212 communicates a card holder funds transfer to a payment processor for the time period that transfers the discount amount for the entry in the affinity company database from the bank account of the affinity company to the affinity credit card holder.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for applying a discount to an account of an affinity credit card holder, comprising:
an affinity company database; and
an affinity company server that
receives a purchase message from a credit card network (CCNET) when an affinity credit card holder makes a purchase,
determines the affinity credit card holder and a merchant identifier (ID) from the message,
determines a discount from the affinity company database using the merchant ID,
calculates a discount amount from the discount,
creates an entry for the discount amount from a merchant with the merchant ID to the affinity credit card holder in the affinity company database,
periodically executes a process that searches the affinity company database for discounts that occurred within a time period,
sums discount amounts for each merchant for the time period, producing a discount amount for the each merchant,
communicates a merchant funds transfer to a payment processor for the time period that transfers each discount amount for the each merchant from a bank account of the each merchant to a bank account of the affinity company, and
communicates a card holder funds transfer to a payment processor for the time period that transfers the discount amount for the entry in the affinity company database from the bank account of the affinity company to the affinity credit card holder.

2. The system of claim 1, wherein the merchant funds transfer and the card holder funds transfer are automated clearing house (ACH) network transfers.

3. The system of claim 1, wherein the card holder transfer transfers the discount amount for the entry in the affinity company database from the bank account of the affinity company to a bank account of the affinity credit card holder.

4. The system of claim 1, wherein the card holder transfer transfers the discount amount for the entry in the affinity company database from the bank account of the affinity company to a credit card account of the affinity credit card holder.

5. The system of claim 1, wherein the time period comprises 30 days.

6. The system of claim 1, further comprising a short message service (SMS) server.

7. The system of claim 6, wherein the affinity company server sends the discount to the SMS server and the SMS server sends the discount as a text to a smartphone of the affinity credit card holder.

8. The system of claim 6, wherein, when the affinity company server further determines the discount includes a promotion, the affinity company server sends the promotion to the SMS server, and the SMS server sends the promotion as a text to a smartphone of the affinity credit card holder.

9. A method for applying a discount to an account of an affinity credit card holder, comprising:
receiving a purchase message from a credit card network (CCNET) when an affinity credit card holder makes a purchase;
determining the affinity credit card holder and a merchant identifier (ID) from the message;
determining a discount from an affinity company database using the merchant ID;
calculating a discount amount from the discount;
creating an entry for the discount amount from a merchant with the merchant ID to the affinity credit card holder in the affinity company database;
periodically executing a process that searches the affinity company database for discounts that occurred within a time period;
summing discount amounts for each merchant for the time period, producing a discount amount for the each merchant;
communicating a merchant funds transfer to a payment processor for the time period that transfers each discount amount for the each merchant from a bank account of the each merchant to a bank account of the affinity company; and
communicating a card holder funds transfer to a payment processor for the time period that transfers the discount amount for the entry in the affinity company database from the bank account of the affinity company to the affinity credit card holder.

10. The method of claim 9, wherein the merchant funds transfer and the card holder funds transfer are automated clearing house (ACH) network transfers.

11. The method of claim 9, wherein the card holder transfer transfers the discount amount for the entry in the affinity company database from the bank account of the affinity company to a bank account of the affinity credit card holder.

12. The method of claim 9, wherein the card holder transfer transfers the discount amount for the entry in the affinity company database from the bank account of the affinity company to a credit card account of the affinity credit card holder.

13. The method of claim 9, wherein the time period comprises 30 days.

14. The method of claim 9, further comprising sending the discount to an SMS server that sends the discount as a text to a smartphone of the affinity credit card holder.

15. A computer program product, comprising a non-transitory tangible computer-readable storage medium whose contents cause a processor to perform a method for applying a discount to an account of an affinity credit card holder, comprising:
providing a system, wherein the system comprises one or more distinct software modules, and wherein the distinct software modules comprise an interaction control process (ICP) module, a database process module, and a payment processor module;
receiving a purchase message from a credit card network (CCNET) when an affinity credit card holder makes a purchase using the ICP module;
determining the affinity credit card holder and a merchant identifier (ID) from the message using the database process module;
determining a discount from an affinity company database using the merchant ID using the database process module;
calculating a discount amount from the discount using the database process module;
creating an entry for the discount amount from a merchant with the merchant ID to the affinity credit card holder in the affinity company database using the database process module;
periodically executing a process that searches the affinity company database for discounts that occurred within a time period using the database process module;
summing discount amounts for each merchant for the time period, producing a discount amount for the each merchant using the database process module;
communicating a merchant funds transfer to a payment processor for the time period that transfers each discount amount for the each merchant from a bank account of the each merchant to a bank account of the affinity company using the payment processor module; and
communicating a card holder funds transfer to a payment processor for the time period that transfers the discount amount for the entry in the affinity company database from the bank account of the affinity company to the affinity credit card holder using the payment processor module.
